(19) United States
(12) Patent Application Publication
(10) Pub. No.: US 2017/0232441 A1
(43) Pub. Date: Aug. 17, 2017

(54) APPARATUS AND METHOD FOR THERMOCYCLIC BIOCHEMICAL OPERATIONS

(71) Applicants: Nelson Nazareth, Upper Dean (GB); David Edge, Warlingham (GB); Adam Tyler, Burton Latimer (GB)

(72) Inventors: Nelson Nazareth, Upper Dean (GB); David Edge, Warlingham (GB); Adam Tyler, Burton Latimer (GB)

(21) Appl. No.: 15/330,040

(22) PCT Filed: Jan. 28, 2015
(86) PCT No.: PCT/GB2015/000028

§ 371 Date: Jul. 29, 2016

(30) Foreign Application Priority Data
Jan. 29, 2014 (GB) 1401584.6

(51) Int. Cl. B01L 7/00; B01L 9/06; G01N 21/64; G01N 35/00; G01N 35/02; B01L 3/00; B01L 9/00

(52) U.S. Cl. CPC B01L 7/52; B01L 3/50851; B01L 9/06; B01L 9/523; B01L 3/502753; G01N 35/0099; G01N 35/028; G01N 21/6428; G01N 21/6456; B01L 2200/025; B01L 2200/028; B01L 2300/0654; B01L 2300/0672; B01L 2300/0829; B01L 2300/1822; B01L 2300/185; B01L 2400/0421; B01L 2300/0681; B01L 2200/147; B01L 2200/04; G01N 2035/00396; G01N 2035/00326; G01N 2021/6417; G01N 2021/6439

(57) ABSTRACT

An amplicon separation apparatus and process for enabling the identification of a plurality of target DNA molecules in a sample such as blood, the apparatus including a consumable and a docking instrument for receiving the consumable. The consumable incorporates a reaction vessel heating station, a reaction vessel content transfer station, an amplicon size separation station, and a reader station. The instrument controls and monitors the consumable and the operation thereof.

### FIELD OF THE INVENTION

The present invention relates to the detection of a particular DNA amplicon in situations where there can be a multiplicity of different DNAs and where rapid detection is desirable. A particular objective to such detection is the identification in a blood sample of a bacterium responsible for causing septicaemia.

### SUMMARY OF THE INVENTION

An object of the invention is the provision of a device and process that can complete a rapid PCR (polymerase chain reaction) of size and colour labelled amplicons and then transfer the reaction in an automated fashion to a size separation mechanism within the same instrument. The benefits of the approach are to greatly reduce the time taken for such assays, simplify operation and equipment and increase the number of targets that can be identified in a single reaction.

According to a first aspect of the present invention there is provided a consumable incorporating the following stations:
a heating station wherein is held a reaction vessel;
a reaction vessel content transfer station;
an amplicon size separation station; and
a reader station.

Typically the heating station holds a reaction vessel in a precise location therein and the consumable is constructed to permit a thermocycler device to be offered into the first station from below the consumable and withdrawn therefrom when the PCR is complete.

The preferred reaction vessel is one which is formed of a carbon loaded plastics material. With such a reaction vessel heat can rapidly be transferred into and out of the reaction chamber. Such a microtitre vessel may be of the order of 2 cm overall length and comprise, in descending order, a cap receiving rim, a filler portion, and a reaction chamber with a base thereto. The filler portion may have a maximum outer diameter of 7-8 mm and a depth of about 4-5 mm and the reaction chamber tapering down from 3 mm to 2.5 mm, the whole having a wall thickness of the order of 0.8 mm. Accordingly the reaction vessel may be of substantially capillary dimensions in order to maximize the rates of heat transfer.

The reaction vessel will normally have a transparent lid fitted thereto which may be hingedly attached thereto or to the consumable.

The reaction vessel may be arranged to contain the required reagents for a PCR process. These may be freeze dried although liquid reagents can be used.

The consumable may incorporate a shuttle device operable to transfer the reaction vessel from the heating station to the content transfer station.

The consumable content transfer station may have piercing means for piercing the reaction vessel and allowing, probably constraining, the vessel content to pass into the size separation station. Associated with the piercing means may be a device in the consumable arranged to urge the vessel down thereonto, or vice versa. The contents transfer station may comprise means for wicking reaction fluid into a collection well on the chip and thus to transfer fluid from a completed reaction to the size separation chip. The reaction vessel may be pressurised, perhaps by virtue of being sealed by a lid therefor and heated, to enable the contents thereof to be driven out.

According to a feature of this first aspect of the invention the amplicon size separation station may be arranged to operate by electrophoresis and thus may comprise a microfluidic chip, that is a chip having an elongated capillary arranged to contain reagents and, if necessary, means enabling target DNA species to be detected. The chip may contain one or more microfabricated channels in which the size separation will take place. In the preferred embodiment this chip is of a glass construction, for its optical properties, but various plastics and other materials can be employed instead. It will be appreciated that in such a size separation station the amplicons will migrate along the capillary at a rate dependent upon their size. The amplicons then arrive separately at a given distance along the capillary where they can each be analysed.

For electrophoresis to be employed in order to effect size separation of DNA amplicons an electric current and a sieving matrix are required. Electrical contacts may accordingly be provided to the consumable, connected to the chip. A suitable sieving matrix may be POP4 or POP6.

The consumable preferably comprises a substantially rigid case and has only one moving part, that moving part including the reaction vessel holder and arranged to move the holder the small distance from the reaction to the contents transfer stations. The moving part preferably comprises a flexible member. The consumable may also have a locking probe by which the consumable can be locked in place.

Ideally the consumable comes with a removable film over the top and bottom surface, covering the vessel and heater accesses. Thus the consumable can be constructed for being loaded with target DNA, for example in blood, in the field.

It will be appreciated that the consumable is advisedly constructed to ensure that none of the reaction vessel content can leak at any time. It will also be appreciated that a consumable in accordance with the invention can be a simple device, of the minimum dimensions reasonably possible and constructed for a minimal number of manual interventions and at minimum cost consistent with being disposable. The consumable may accordingly be a rectangular box of the order of 12 cm total length, 23 mm breadth and 28 mm depth.

According to a second aspect of the invention there is provided an instrument in the form of a docking station constructed to receive and hold the consumable of the first aspect of the invention, the docking station incorporating the thermocycler device.

A preferred thermocycler device comprises a metal sleeve adapted snugly to surround the reaction vessel reaction chamber in such a manner as to be contiguous therewith throughout the length thereof and, integral with the sleeve at the base thereof, a heat transfer module. The heat transfer module may be a peltier cell attached to a heat reduction module (HRM) arranged for operation around a median temperature, that temperature being typically around the annealing temperature of an average DNA. As an alternative to the peltier cell there may be heater wire windings around the sleeve overlapping the vessel reaction chamber.

The instrument preferably incorporates one, more or all of:
a consumable reception hatch;
an openable consumable position lock
offering means arranged to insert the thermocycler into the consumable so that the sleeve surrounds the reaction vessel;
means, typically optical, for monitoring the PCR process in the reaction vessel;
a pusher for moving the reaction vessel from the heating station to the contents transfer station;
means, perhaps an above-the-lid heater, for demisting the lid and pressurizing the contents of the reaction vessel;
a device for causing the reaction vessel to be urged onto the vessel contents transfer station;
heater means operable to maintain the amplicon size separation station at a constant temperature;
camera means, preferably optical, arranged to interrogate the consumable reader station;
means arranged for the supply of electricity to the chip contacts;
control means; and
results read out means.

The docking station may be constructed to receive and process a plurality of consumables, preferably with the ability to start a second running while another is under way.

Preferably the reader means comprises an optical arrangement, typically incorporating a spectrophotometer relying on LED excitation and CCD detection. The reader means may also incorporate means to maintain a time base in order that fluorescence can be plotted against time and hence the size of products can be extrapolated.

It will be appreciated that the docking station may incorporate control software and a user interface and/or be associated with a computer for control, monitoring and recordal purposes. The software may incorporate the ability to automate operation of the apparatus. Thus a user may need merely to load the chip into the docking station, switch on, and the instrument will do the rest. The software may therefore provide feedback means for monitoring the process, time temp etc. The software may also provide the end user a result by comparing the observed sizes and spectra to a known database.

As between the consumable and the docking station temperature control means may be incorporated at the size separation station, since the electrophoresis generates heat whilst variation in temperature can alter the rate at which samples migrate in the size separation station. Accordingly there may be in the docking station a heat exchanger, such as a heat reduction module (HRM) arranged for chip temperature control. This can serve to maintain a particular constant temperature for reproducibility reasons or to maintain a different constant temperature to cater for different tests.

According to a third aspect of the invention there is provided a process employing the consumable and the instrument, the process being for the rapid detection of large numbers of DNA targets, for example pathogens present in a sample of blood.

The process may comprise at least most of the following:
loading extracted DNA into the reaction vessel of the consumable, the consumable already containing the reagents and primers, preferably fluorescently labelled, necessary to detect a target DNA species;
loading the loaded consumable into the docking station;
subjecting the vessel to thermal cycling;
upon completion of the thermal cycling withdrawing the heating apparatus from the consumable;
transferring the vessel from the heating to the vessel contents transfer station;
urging the vessel onto the vessel base piercer and thus piercing the vessel base and allowing the vessel contents to flow into the size separation channel in the size separation station;
whilst controlling the temperature of the size separation channel causing labelled amplicons to progress therealong;
monitoring optically the arrival of amplicons at a particular station;
generating the spectral profiles of labelled amplicons;
plotting which spectra were observed against a time base;
via comparison to an allelic ladder of known size determining the size and colour and hence the identity of any amplicons detected.

After the step of allowing the vessel contents to flow into the size separation channel the vessel contents enter a sieve matrix. Preferably it is electrophoresis which drives the amplicons along the separation channel.

The process may also include, where necessary, a cell disruption step wherein prior to PCR the contents of the reaction vessel may be either or both of freezing and thawing and boiling and cooling, this to break open cells to access particular DNA.

The apparatus and process of the invention can detect one or more target species but with an upper limit of quantity higher than existing approaches.

In certain circumstances real-time observation of the reaction, particularly the progress of the amplicons in the separation channel, may be desired and this can readily be realized in apparatus according to the invention.

Embodiments of the invention will now be described by way of example, with reference to the accompanying drawings, of which:

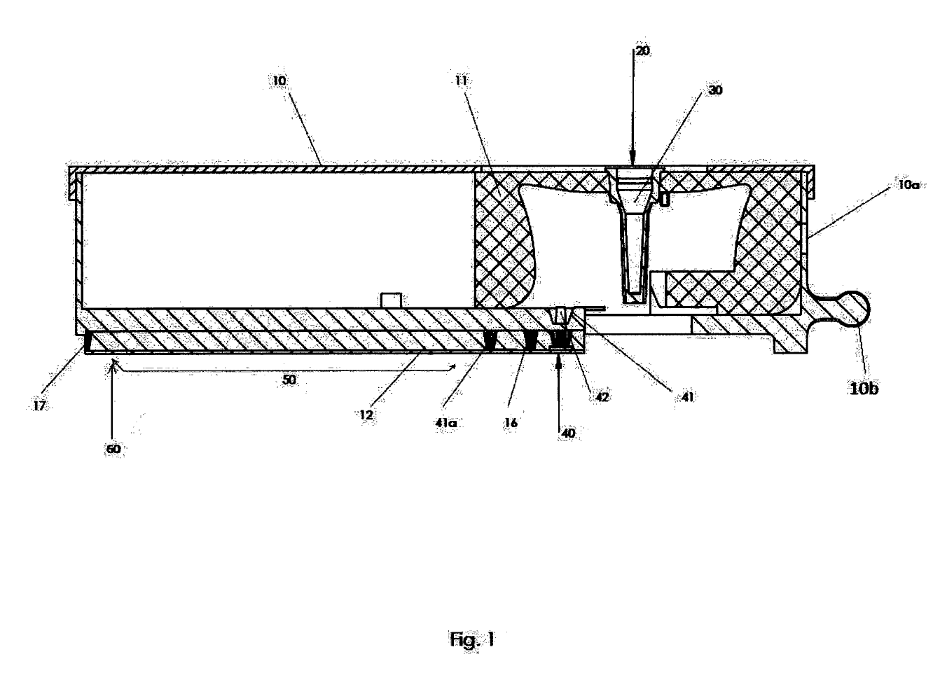

FIG. 1 is a sectioned side elevation of a consumable in a first configuration;

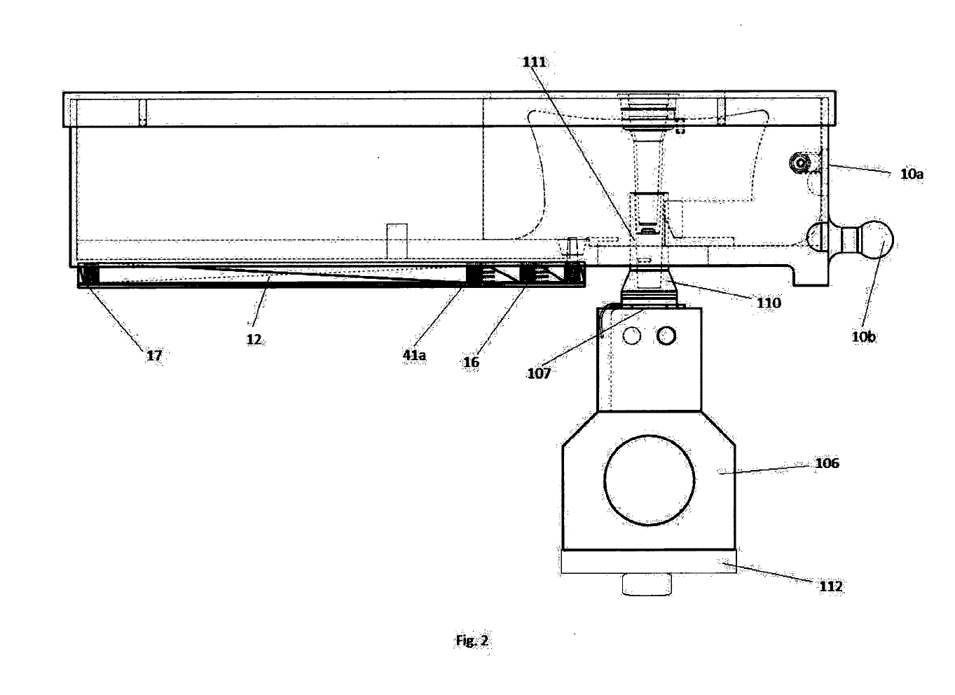

FIG. 2 is a sectioned side elevation of a PCR heater engaging a microtitre reaction vessel;

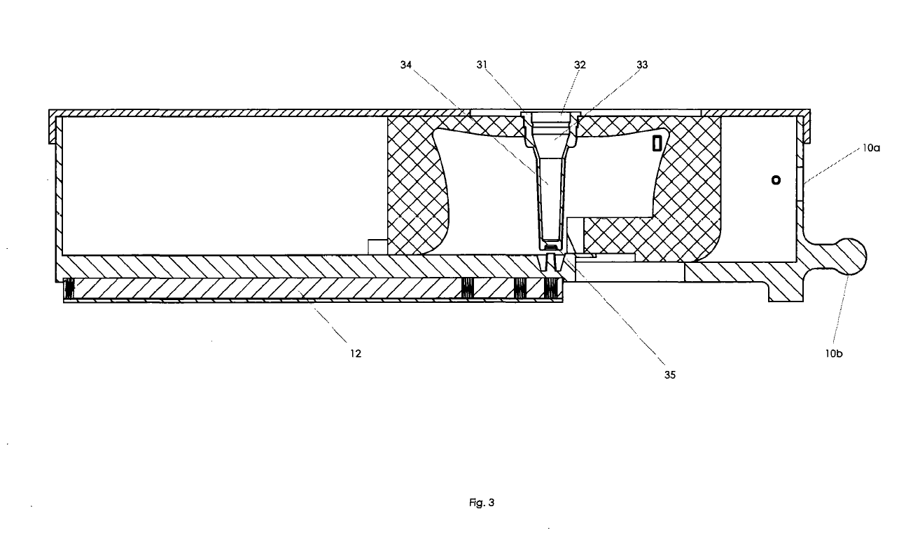

FIG. 3 is a sectioned side elevation of a consumable in a second configuration;

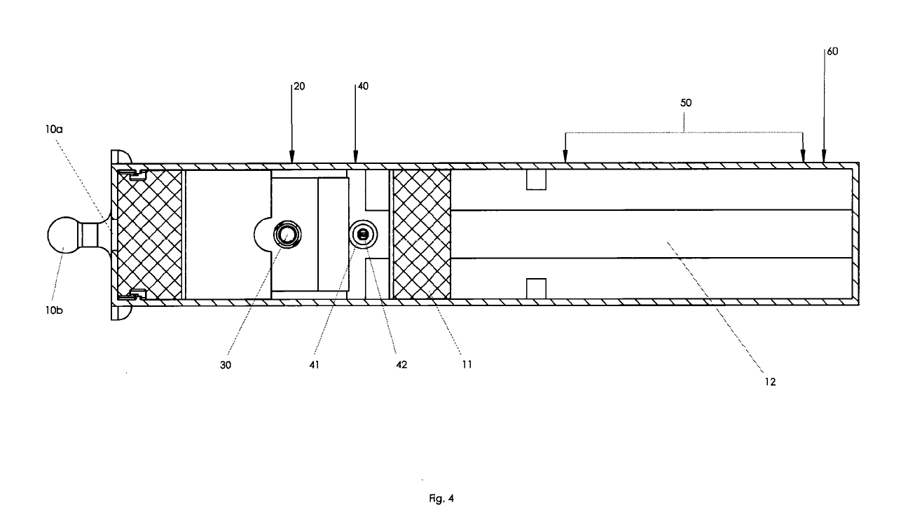

FIG. 4 is a sectioned plan view of a consumable in the first configuration;

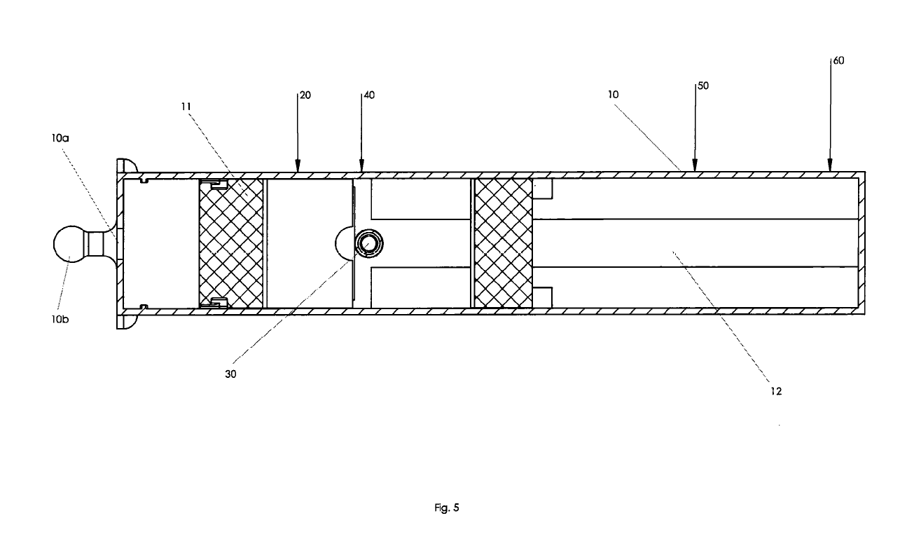

FIG. 5 is a sectioned plan view of a consumable in the second configuration;

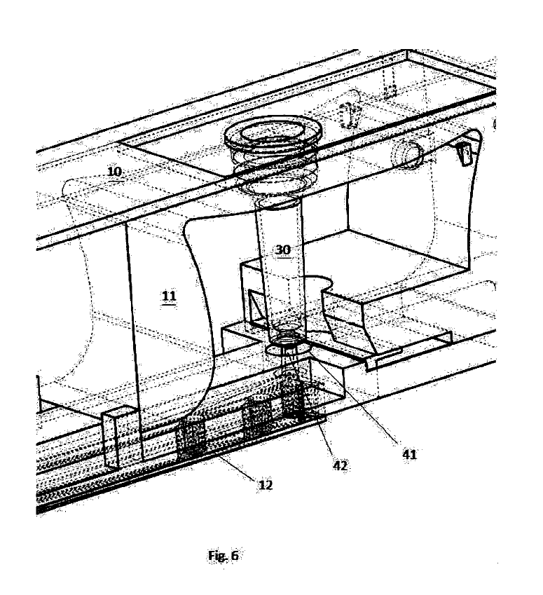

FIG. 6 illustrates detail of a reaction vessel content transfer station;

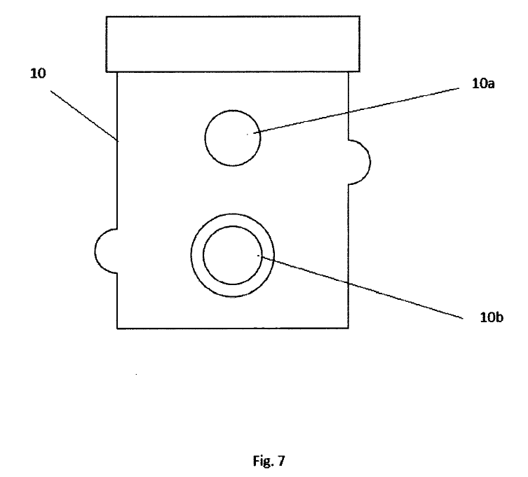

FIG. 7 is an insertion end view of a consumable;

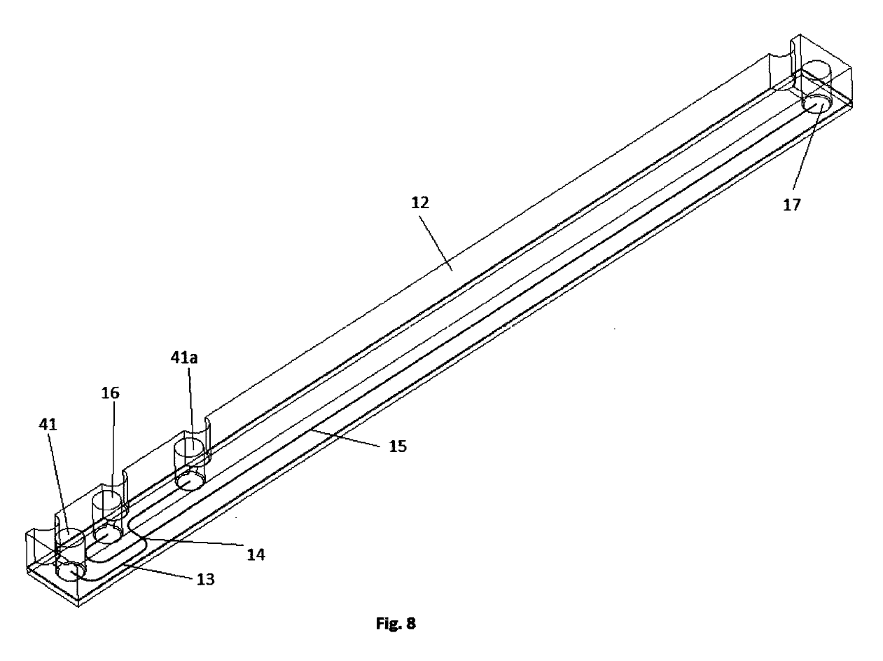

FIG. 8 is an isometric view of a chip;

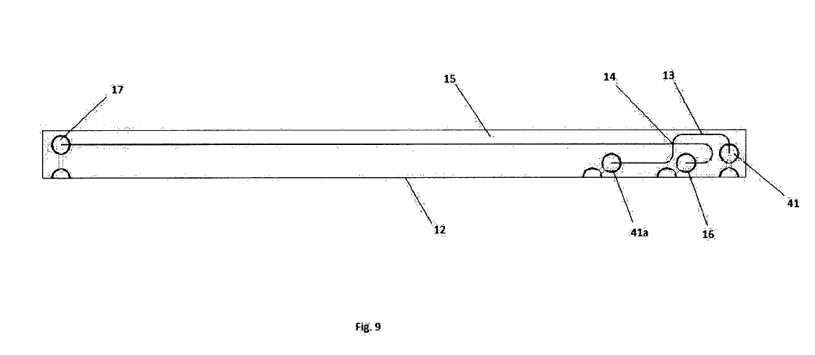

FIG. 9 is a schematic plan view of a chip;

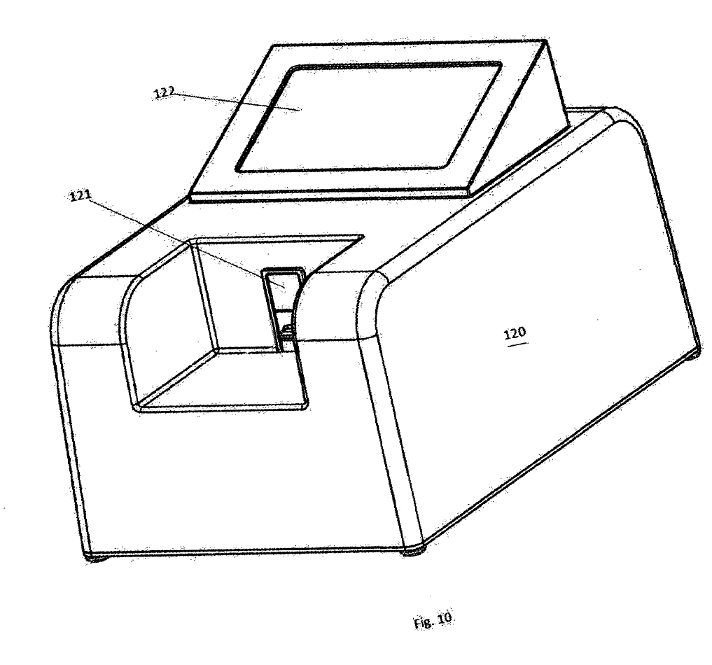

FIG. 10 illustrates the exterior of a docking station;

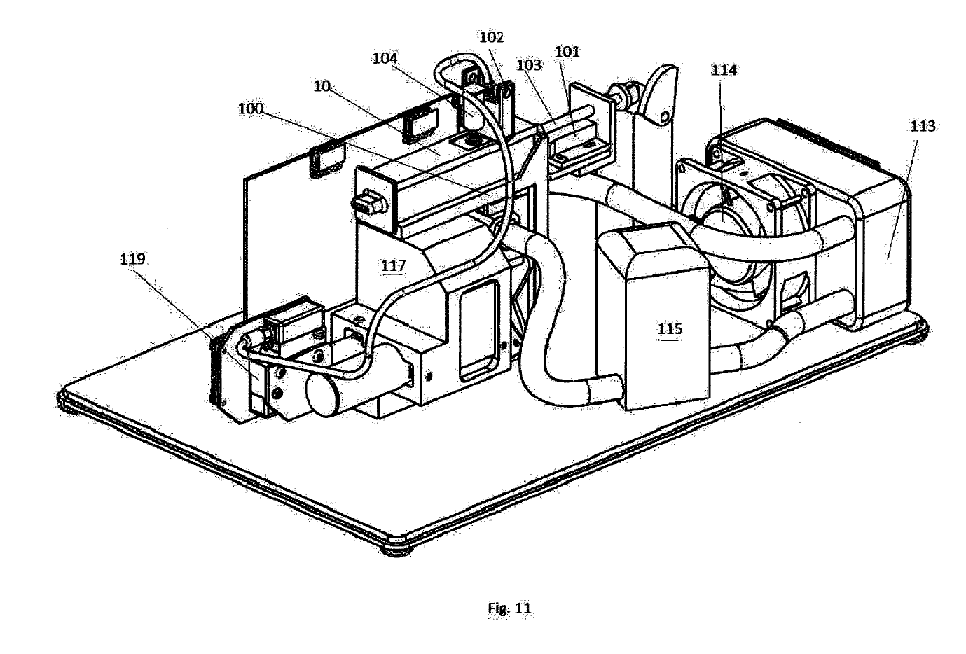

FIG. 11 depicts the content of a docking station;

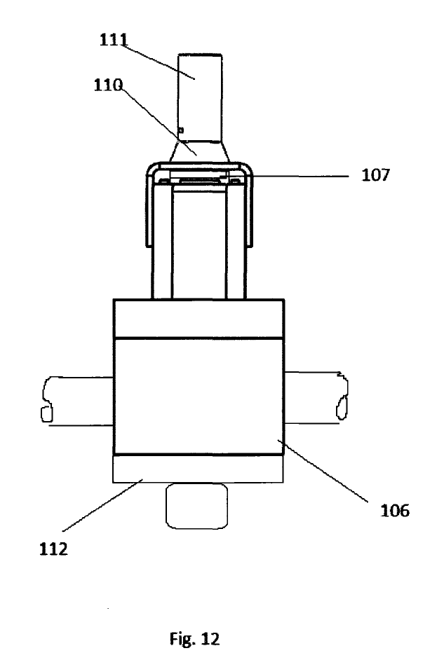

FIG. 12 is a sectional view of a PCR heater;

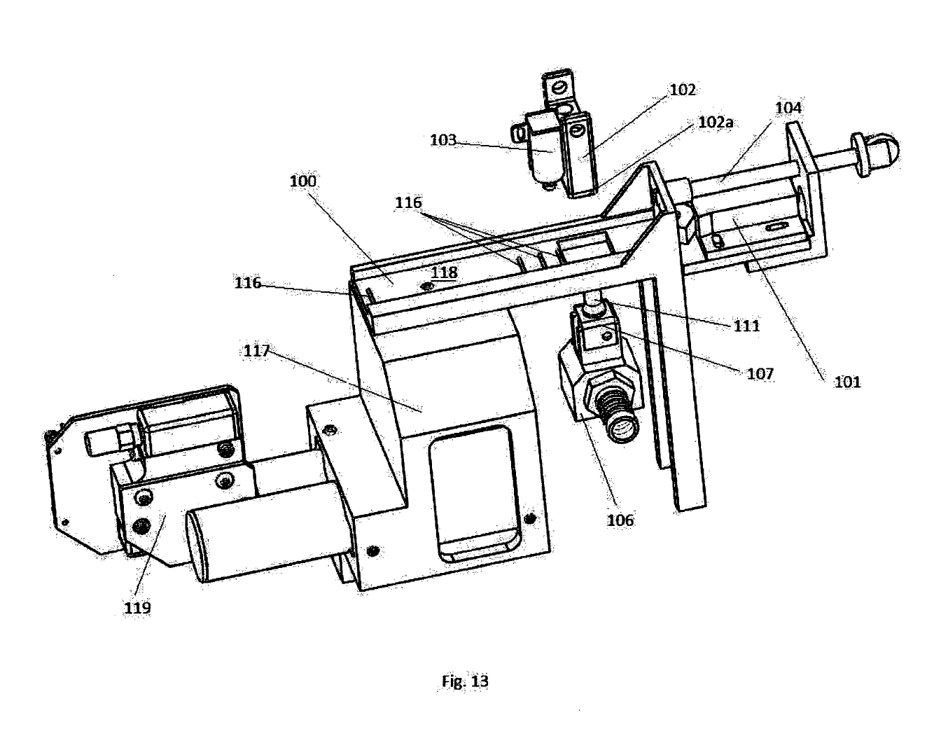

FIG. 13 is a detail view of the docking station table area;

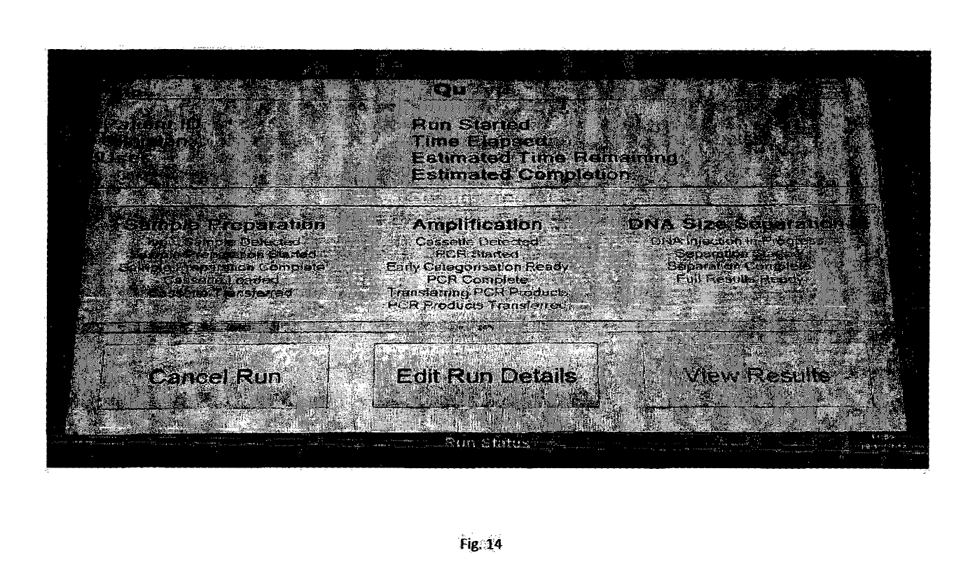

FIG. 14 illustrates a display on the docking station screen.

Depicted in FIGS. 1 to 9 is an amplicon separation consumable comprising a case 10 and incorporating the following stations:
a heating station 20 holding a reaction vessel 30;
a reaction vessel content transfer station 40;
an amplicon size separation station 50; and
a reader station 60.

At the heating station 20 is a mitrotitre reaction vessel 30. The reaction vessel 30 is formed of a carbon loaded plastics material and is 2 cm overall length. It comprises, in descending order, a cap receiving rim 31 with a lid 32 flexibly attached thereto, a filler portion 33, a reaction chamber 34 with a base 35 thereto. The filler portion 33 has a maximum outer diameter of 7-8 mm and a depth of 5 mm. The reaction chamber 34 tapers down from 3 mm to 2.5 mm diameter. The reaction chamber 34 has a wall thickness of the order of 0.8 mm. Accordingly the reaction vessel is of substantially capillary dimensions in order to maximize the rates of heat transfer to and from the vessel contents. The lid 32 fits sealedly to the vessel rim 31.

The reaction vessel 30 is held in the heating station 20 in a configuration rendering the vessel 30 accessible to a lid heater and an optical reader above and a heater below. The reaction vessel 30 is actually held in a shuttle 11 in the consumable 10 accessible via an aperture 10a to be driven from outside the consumable and thereby movable from the heating station 20 to the contents transfer station 40. The consumable case 10 also has formed thereon a probe 10b by which it the consumable can be removably locked into the docking station. The consumable case 10 is also constructed so that it can be offered to the docking station in only one orientation.

At the reaction vessel content transfer station 40 on the floor of the consumable is a well 41 sized to receive sealedly the base 35 of the reaction vessel 30. In the centre of the well 41 is a needle 42 operable to pierce the base 35 and allow the vessel contents to flow into the well 41. At the station 40 the ceiling of the consumable 10 allows access to a solenoid device operable to push the reaction vessel 30 downwards into the well 41 and onto the needle 42. The needle 42 is one which upon piercing the base 35 permits liquid to flow thereby. The needle 42 is a back-to-back “C”.

The well 41 is formed in a glass electrophoresis chip 12 and communicates with a first capillary 13 formed therein. The capillary 13 terminates in a well 41a in the chip 12. Midway along the first capillary 13 is a junction 14 with a second capillary 15. The second capillary 15 extends between a power source well 16 and a terminal well 17. The consumable is arranged so that the reading station is just ahead of the terminal well 17. Electrodes 18 associated with each of the four wells 41, 41a, 16 and 17 serve to drive the electrophoresis. Within the capillaries 13, 15 is a sieving matrix.

The docking station illustrated in FIGS. 10 to 14 has a consumable reception table 100 with a docking lock 101. Above the table 100, opposite the consumable heating station 20 is an optical reader 102 and an associated vessel lid heater 102a, while opposite the fluid transfer station 40 is a device in the form of a screw operated pusher 103 for pushing the vessel down onto the needle 42.

Above the docking lock 101 and ahead of the consumable's aperture 10a is a solenoid operated plunger 104.

The table 100 incorporates a PCR thermocycling device 105. This comprises a HRM 106, a Peltier cell 107 having a base face 108 and a working face 109, a heat exchanger comprising a heat transfer base 110 and a sleeve 111, and a drive 112. The HRM 106, the Peltier cell 107 and the heat transfer base 110 are attached one to another with a flexible solder. The sleeve 111 is formed to engage snugly but removably the reaction vessel 30 in the consumable 10. The HRM is in a heat transfer liquid circuit comprising a radiator 113 and fan 114 and a pump 115.

Upon the table 100, appropriately placed, are contacts 116 for the electrophoresis electrodes 18. Outward of the table 100 and below the level thereof is a camera 117. The table also incorporates, below and throughout the separation station 50, a heater 118. The optical reader 102 and the camera 117 feed a spectrograph 119.

The docking station also incorporates appropriate software.

The docking station has a case 120 incorporating a consumable reception hatch 121 and a touch control display screen 122.

To use the apparatus the vessel reaction chamber 34 is charged with appropriate reagents and fluorescent labelled primers. If these are freeze dried an appropriate amount of pure water is added before the sample to be investigated is added and the transparent lid 32 emplaced.

The docking station is switched on, when the liquid in the HRM circuit will warm up to a selected temperature just above the annealing temperature of the target DNA. Electrical circuitry will supply the touch screen with a signal to indicate the liquid temperature.

The consumable is then pushed into the docking device 120 via the hatch 121 until the probe 10b is engaged by the docking lock 101 and locked in place on the table 100, when the electrical contacts 116 engage the electrophoresis electrodes 18. The hatch 121 also serves to hold the consumable to the table 100.

The optical reader 102 and the lid heater are switched on and the thermocycler 105 moved up by the drive 112 so that the sleeve 111 engages snugly the reaction vessel 30. If required the thermocycler 105 is first arranged to perform a cell disruption cycle before a PCR cycle, which latter is observed by the optical reader 102. A report from the reader 102 enables the screen 122 to indicate that the PCR is complete and to switch off and withdraw the thermocycler 105. The thermocycler 105 is switched off at a little below its higher temperature in order to ensure pressure within the reaction vessel 30, whilst not encouraging a further DNA separation.

The plunger 104 pushes the consumable shuttle 11 from the heater station 20 to the contents transfer station 40. The pusher 103 imposes downward pressure upon the shuttle 11 and pushes the reaction vessel down into the well 41 and onto the needle 42, which penetrates the base 35 of the reaction vessel. Because of pressure retained in the reaction vessel 30 the contents thereof are readily driven out and into the well 41 where they dissipate into the sieving matrix in capillary 13 and migrate therealong. At junction 14 the amplicons are captured and driven along the second capillary 15 by electrophoresis. The smaller amplicons travel the fastest and accordingly all amplicons arrive at the reading station at different times. Both the size and the colour of each amplicon is detected by the camera and a spectral profile of each amplicon generated. The associated software in the docking station will from this information identify the DNA of the amplicon and the identity is displayed on the screen.

The consumable of this embodiment is a rectangular box of 12 cm total length, 23 mm breadth and 28 mm depth. The glass chip 12 is 7.5 cm long by 5 mm broad and 1.5 mm deep. The overall length of the capillary 15 is 7.0 cm. The consumer case 10 has a 1 mm recess in its base to receive and protect the chip. The chip has, as a result, about the minimum possible size consistent with relatively assured integrity and efficient operation, thus allowing construction of a consumable with an economy to be expected of a disposable item.

The docking station 120 has overall dimensions 20 cm length and breadth and 15 cm height.

Parts List

Consumable

Stations:

heating station 20; reaction vessel 30; vessel content transfer station 40; amplicon size separation station 50; reader station 60.

Parts:

consumable case 10; shuttle 11; aperture 10a probe 10b; vessel cap receiving rim 31; lid 32; filler portion 33; reaction chamber 34; base 35; electrophoresis chip 12; first capillary 13; junction 14; second capillary 15; power source well 16; reading station well 17; electrodes 18; receiver well 41; needle 42; sink well 41a.

Docking Station

reception table 100; docking lock 101; optical reader 102; solenoid operated plunger 103; solenoid operated plunger 104; thermocycler 105; HRM 106; Peltier cell 107; base face 108; working face 109; heat exchanger heat transfer base 110; sleeve 111; drive 112; radiator 113; fan 114; pump 115; contacts 116; camera 117; case 118; hatch 119; screen 120.

1-61. (canceled)

62. An amplicon separation consumable incorporating the following stations:
a heating station adapted to receive and hold a microtitre reaction vessel having a reaction chamber and a base;
a reaction vessel content transfer station;
an amplicon size separation station; and
a reader station.

63. A consumable as claimed in claim 62 and wherein the heating station is constructed to receive withdrawably a thermocycler device, the thermocycler device being constructed to envelop the reaction chamber of a reaction vessel.

64. A consumable as claimed in claim 62 and incorporating a shuttle device operable to transfer the reaction vessel from the heating station to the reaction vessel content transfer station.

65. A consumable as claimed in claim 62 and wherein the consumable content transfer station has piercing means arranged for piercing the reaction vessel base and allowing vessel content to pass into the size separation station.

66. A consumable as claimed in claim 62 and wherein the amplicon size separation station includes a size separation microfluidic chip.

67. A consumable as claimed in claim 66 and wherein the reaction vessel transfer station comprises means for wicking reaction fluid into a collection well on the chip and thus to transfer fluid from a completed reaction to the size separation chip.

68. A consumable as claimed in claim 62 and wherein the amplicon size separation station contains a sieving matrix.

69. An amplicon separation consumable incorporating the following stations:
a heating station wherein is held a reaction vessel;
a reaction vessel content transfer station;
an amplicon size separation station; and
a reader station, the heating station being constructed to receive withdrawably a thermocycler device offered into the heater station from below the consumable and arranged to nestle snugly a reaction chamber part of the reaction vessel;
the reaction vessel being formed of a carbon loaded plastics material and being of microtitre proportions with a length of 2 cm a filler portion with a maximum outer diameter of 7-8 mm and a depth of about 4-5 mm, the reaction chamber tapering down from 3 mm to 2.5 mm, the whole having a wall thickness of the order of 0.8 mm, the reaction vessel thus being of substantially capillary dimensions and comprising in descending order, a cap receiving rim and a transparent cap therefor, a filler portion, a reaction chamber with a base and containing required reagents and fluorescently labelled primers, freeze dried, for a PCR process;
the consumable having a shuttle device operable to transfer the reaction vessel from the heating station to the content transfer station;
the content transfer station having piercing means arranged for piercing a base of the reaction vessel and allowing the vessel content to pass into the size separation station;
the amplicon size separation station including a size separation glass microfluidic chip, arranged for operation by electrophoresis and containing a sieving matrix;
electrical contacts, connected to the size separation station wherethrough an electrical current may be supplied to drive amplicon size separation;
the consumable comprising a substantially rigid case and having a removable film over top and bottom surfaces thereof, covering reaction vessel and heater accesses; and
the reader station being accessible by optical interrogation means.

70. An amplicon separation instrument in the form of a docking station constructed to receive and hold a consumable as claimed in claim 62, the docking station incorporating a thermocycler device.

71. An instrument as claimed in claim 70 and wherein the thermocycler device comprises a metal sleeve adapted snugly to surround the reaction vessel reaction chamber in such a manner as to be contiguous therewith throughout the length thereof and, integral with the sleeve at the base thereof, a heat transfer module.

72. An instrument as claimed in claim 71 and wherein the heat transfer module is a peltier cell attached to a heat reference module and arranged for operation around a median temperature.

73. An instrument as claimed in claim 70 and incorporating monitoring means operable to monitor progress of PCR within the reaction vessel.

74. An instrument as claimed in claim 70 and incorporating a device arranged to determine that the reaction vessel can be moved and to cause the reaction vessel to be moved in the consumable from the heating station to the reaction vessel contents transfer station.

75. An instrument as claimed in claim 70 and incorporating reader means arranged to interrogate the consumable reader station.

76. An instrument as claimed in claim 70 and incorporating temperature control means operable to control the temperature of the consumable amplicon size separation station.

77. An instrument as claimed in claim 70 and having an automated opening drawer arranged to receive and eject a consumable.

78. An instrument as claimed in claim 70 and constructed to receive and process a plurality of consumables simultaneously.

79. An instrument as claimed in claim 70 and arranged to provide a result of comparing observed amplicon sizes and spectra to a known database.

80. An instrument as claimed in claim 70 and having an optical facility which incorporates a spectrophotometer relying on LED excitation and CCD detection.

81. An amplicon separation instrument in the form of a docking station constructed to receive and hold a consumable as claimed in claim 1, the docking station comprising:
a thermocycler device, the thermocycler device including a metal sleeve adapted snugly to surround the reaction vessel reaction chamber in such a manner as to be contiguous therewith throughout the length thereof and, integral with the sleeve at the base thereof, a heat transfer module, the heat transfer module being a peltier cell attached to a heat reference module and arranged for operation around a median temperature;
offering means arranged to insert the thermocycler into the consumable so that the sleeve surrounds the reaction vessel;
monitoring means operable to monitor the progress of PCR within the reaction vessel, the monitoring means being operable to determine that the PCR is complete;
a device arranged to determine that the reaction vessel can be moved and to move the reaction vessel in the consumable from the heating station to the contents transfer station;
reader means arranged to interrogate the consumable reader station, the reader means comprising an optical facility incorporating an LED excitation source and a spectrophotometer, the reader means further incorporating means to maintain a time base in order that fluorescence can be plotted against time; and
temperature control means operable to control the temperature of the consumable size separation station.
